(19) United States
(12) Patent Application Publication
(10) Pub. No.: US 2012/0252565 A1
(43) Pub. Date: Oct. 4, 2012

(54) SYSTEM AND METHOD FOR CONTROLLING AN ELECTRONIC GAMING MACHINE

(76) Inventors: Peter Scott Clarebrough, Newington (AU); Vincent Carmelo Bruzzese, Newington (AU)

(21) Appl. No.: 13/515,289

(22) PCT Filed: Dec. 9, 2010
(86) PCT No.: PCT/AU2010/001665

§ 371 Date: Jun. 12, 2012

(30) Foreign Application Priority Data
Dec. 9, 2009 (AU) 2009906009

(51) Int. Cl. A63F 13/12; A63F 13/02

(52) U.S. Cl. 463/25; 463/42; 463/31

(57) ABSTRACT

A system (1) for controlling an electronic gaming machine (EGM) (2) in accordance with one or more playing parameters (3) of a user (4) comprises a computer programmable medium (CPM) (5) for storing playing parameter data (6) relating to the one or more playing parameters and a computer (7) for receiving the CPM, wherein the user (4) enters or updates the playing parameter data (6) on the CPM (5). The system (1) has an EGM (2) comprising a controller (8) for controlling operation of the and a device (9) for communicating with the CPM (5). The communicating device (9) retrieves the playing parameter data (6) from the CPM (5) and transfers the playing parameter data to the controller (8), such that the controller uses the playing parameter data to operate the EGM (2) in accordance with the one or more playing parameters (3). A corresponding method (40) is provided.

### FIELD OF THE INVENTION

The present invention relates to a system and method for controlling an electronic gaming machine and in particular to a system and method for controlling an electronic gaming machine according to a user's predefined playing parameters.

The invention has been developed primarily for use in controlling an electronic gaming machine according to a user's betting preferences and limits. However, it will be appreciated that the invention is not limited to this particular field of use.

### BACKGROUND OF THE INVENTION

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

In Australia, various state governments have mandated regulations to inhibit or prevent “problem” gamblers from betting excessive monetary amounts at casinos, clubs and other similar gaming venues. Such problem gamblers tend to demonstrate addictive behaviour in the sense that they are not able to control their gambling behaviour, that potentially results in significant financial losses that lead to adverse personal, social, economic and health effects upon the problem gambler and his or her family. Current legal and regulatory measures require gaming venues and operators to identify, and monitor problem gamblers, and intervene when they begin to excessively gamble. However, gaming venues and operators find these measures difficult to comply with, as problem gamblers can be difficult to identify and monitor without being constantly watched by another person or system. Moreover, a person may be misidentified as a problem gambler by gaming venue or operator. In addition, problem gamblers are frequently uncooperative and do not wish to be identified for various reasons, including avoiding social stigma, keeping their privacy or hiding their problem. Thus, gaming venues and operators have to devote considerable resources and incur a significant financial and administrative burden to meet their legal compliance requirements.

Another problem with the current regime is that these measures tend to be less effective once a problem gambler begins to gamble, as the problem gambler tends to be caught up in playing games and lose their self-control in limiting their losses, amount of bets or time spent gambling.

It is an object of the present invention to overcome or substantially ameliorate one or more of the disadvantages of prior art, or at least to provide a useful alternative.

It is an object of the invention in its preferred form to provide a system and method for controlling an electronic gaming machine according to one or more playing parameters of a user.

### SUMMARY OF THE INVENTION

One aspect of the invention provides a system for controlling an electronic gaming machine in accordance with one or more playing parameters of a user, the system comprising:
a computer programmable medium for storing playing parameter data relating to the one or more playing parameters;
a computer for receiving the computer programmable medium, wherein the user enters or updates the playing parameter data on the computer programmable medium; and
an electronic gaming machine comprising:
   a controller for controlling operation of the electronic gaming machine; and
   a device for communicating with the computer programmable medium,
wherein the communicating device retrieves the playing parameter data from the computer programmable medium and transfers the playing parameter data to the controller, such that the controller uses the playing parameter data to operate the electronic gaming machine in accordance with the one or more playing parameters.

Another aspect of the invention provides a method of controlling an electronic gaming machine in accordance with one or more playing parameters of a user, the method comprising the steps of:
storing playing parameter data relating to the one or more playing parameters on a computer programmable medium; and
transferring the playing parameter data from the computer programmable medium to a controller of the electronic gaming machine, such that the controller uses the playing parameter data to operate the electronic gaming machine in accordance with the one or more playing parameters.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Preferably, the computer programmable medium stores playing history data relating to the playing history of the user, and the communicating device retrieves the playing history data from the computer programmable medium and transfers the playing history data to the controller, wherein the controller compares the playing history data with the playing parameter data for compliance with the one or more playing parameters before permitting the user to play a game on the electronic gaming machine.

Preferably, after each game that is played on the electronic gaming machine, the controller updates the playing history data on the computer programmable medium.

Preferably, before each game that is played on the electronic gaming machine, the controller compares the playing history data against the playing parameter data to check that playing a game on the electronic gaming machine complies with the one or more playing parameters. Alternatively, after each game that is played on the electronic gaming machine, the controller compares the playing history data against the playing parameter data to check that playing another game on the electronic gaming machine complies with the one or more playing parameters.

Where playing a game on the electronic gaming machine would comply with the one or more playing parameters, the controller permits the user to play a game on the electronic gaming machine.

Where playing a game on the electronic gaming machine would not comply with the one or more playing parameters, the controller prevents operation of the electronic gaming machine. In this case, in one preferred form, the controller then instructs the communicating device to display a status screen on the electronic gaming machine advising the user that one or more of the playing parameters have not been complied with.

Preferably, the electronic gaming machine would permit the user to adjust one or more parameters of the game on the electronic gaming machine to comply with the one or more playing parameters. If it is not possible to adjust one or more parameters of the game on the electronic gaming machine to comply with the one or more playing parameters, then the controller would prevent a game being played on the electronic gaming machine.

Preferably, the one or more playing parameters comprises the maximum bet limit, banknote acceptance limit for the electronic gaming machine, the maximum number of banknotes inserted into the electronic gaming machine, the maximum monetary loss on a single machine, the maximum credit on the electronic gaming machine, the maximum accumulated monetary loss, the maximum session turnover, the maximum time spent on the electronic gaming machine and the maximum time spent on multiple electronic gaming machines. More preferably, the one or more playing parameters have one of more predetermined time limits. In one preferred form, at least one of the predetermined time limits is a playing session time limit.

Preferably, the playing history data comprises one or more of the number of bets made by the user, the amount of each bet made by the user, the accumulated amount of bets made by the user, the denomination of banknote(s) inserted into any electronic gaming machine, the total number of banknotes inserted into electronic gaming machines, the turnover for the session on the electronic gaming machine, the maximum credit on the electronic gaming machine, the accumulated monetary loss of the user and the amount of time the user has been playing electronic gaming machines.

Preferably, the playing history data and/or the one or more playing parameters are visually displayed on the electronic gaming machine to the user before a game is played on the electronic gaming machine. Alternatively or additionally, the playing history data and/or the one or more playing parameters are visually displayed on the electronic gaming machine in response to a command from the user. More preferably, the communicating device retrieves the playing history data and the playing parameter data from the computer programmable medium and generates graphical data of the playing history data and/or the one or more playing parameters for display on the electronic gaming machine.

Preferably, the controller records session data relating to the use of the electronic gaming machine by the user. More preferably, the communicating device transfers the session data from the controller to the computer programmable medium. In one preferred form, the session data is displayed with the playing parameters and/or playing history data on the electronic gaming machine.

Preferably, the playing history data is reset after expiry of the one or more predetermined time limits. More preferably, the one or more predetermined time limits correspond to the time limits for the playing parameters. In one preferred form, one predetermined time limit is a playing session time limit.

Preferably, the computer is in communication with a central database for verifying the playing parameter data on the computer programmable medium. Alternatively, or additionally, the computer is in communication with a validation computer for verifying the playing parameter data on the computer programmable medium and activating the computer programmable medium for use with the electronic gaming machine.

Preferably, the method further comprises the steps of storing playing history data relating to the playing history of the user, transferring the playing history data from the computer programmable medium to the controller and comparing the playing history data with the playing parameter data for compliance with the one or more playing parameters, before permitting the user to play a game on the electronic gaming machine. More preferably, the method further comprises performing the data comparing step before each game that is played on the electronic gaming machine.

Preferably, the method further comprises updating the playing history data on the computer programmable medium after each game that is played on the electronic gaming machine. More preferably, the data comparing step is performed after the playing history data updating step.

Preferably, the method comprises the step of permitting the user to play a game on the electronic gaming machine if playing a game on the electronic gaming machine would comply with the one or more playing parameters. More preferably, the method comprises the step of preventing operation of the electronic gaming machine if playing a game on the electronic gaming machine would not comply with the one or more playing parameters. In one preferred form, the method comprises the step of communicating a signal to the communicating device to display a status screen on the electronic gaming machine advising the user that one or more of the playing parameters would not be complied with.

Preferably, the method comprises the step of permitting the user to adjust one or more parameters of the game on the electronic gaming machine to comply with the one or more playing parameters.

Preferably, the method comprises the step of displaying the playing history data and/or the one or more playing parameters on the electronic gaming machine. More preferably, the displaying step is performed before a game is played on the electronic gaming machine.

Preferably, the method comprises the steps of retrieving the playing history data and the playing parameter data from the computer programmable medium and generating graphical data from the playing history data and/or the one or more playing parameters for display on the electronic gaming machine. More preferably, the user activates the displaying step. In this case, the method further comprises the step of communicating with the communicating device to activate display of the playing history data and/or the one or more playing parameters.

Preferably, the method comprises the step of recording session data relating to the use of the electronic gaming machine by the user. Preferably, the method comprises the step of displaying the session data with the playing parameters and/or playing history data on the electronic gaming machine. More preferably, the session data displaying step is performed upon activation by the user.

Preferably, the method comprises the step of resetting the playing history data after expiry of the one or more predetermined time limits. More preferably, the one or more predetermined time limits correspond to the time limits for the playing parameters.

Preferably, the method comprises the step of verifying the playing parameter data on the computer programmable medium. Preferably, the method comprises the step of activating the computer programmable medium for use with the electronic gaming machine.

Preferably, the computer programmable medium comprises a memory card, smart card, a radio frequency identification (RFID) device, USB key, magnetic card or other equivalent portable electronic storage device.

Preferably, the communicating device comprises a memory card reader/writer, a smart card reader/writer, a RFID communication device, USB key reader/writer, magnetic card reader/writer or other equivalent portable electronic storage device reader/writer.

### BRIEF DESCRIPTION OF THE DRAWINGS

Preferred embodiments of the invention will now be described, by way of example only, with reference to the accompanying drawings in which:

FIG. 1 is a schematic drawing of a system for controlling an electronic gaming machine according to one embodiment of the invention;

FIG. 2 is a schematic drawing of a screen display on the electronic gaming machine when a user first inserts a smart card in accordance with the system of FIG. 1;

FIG. 3 is a schematic drawing of a screen display on the electronic gaming machine showing the status of a user's playing history in accordance with the system of FIG. 1;

FIG. 4 is a schematic drawing of a screen display on the electronic gaming machine showing that the playing a game would not comply with one or more of the playing parameters in accordance with the system of FIG. 1;

FIG. 5 is a schematic drawing showing implementation of the system of FIG. 1 to a pre-existing electronic gaming machine;

FIG. 6 is a schematic drawing of a system according to another embodiment of the invention; and

FIG. 7 is a schematic drawing of a method for controller an electronic gaming machine according to one embodiment of the invention.

### PREFERRED EMBODIMENTS OF THE INVENTION

Referring to the drawings, a system 1 for controlling an electronic gaming machine (EGM) 2 in accordance with one or more playing parameters 3 of a user 4 comprises a computer programmable medium in the form of a smart card 5 for storing playing parameter data 6 relating to the one or more playing parameters 3 and a computer 7 for receiving the smart card, wherein the user 4 enters or updates the playing parameter data 6 on the smart card 5. The system 1 also comprises the EGM 2, which has an internal controller 8 for controlling operation of the EGM and a device in the form of a smart card reader/writer 9 for communicating with the smart card 5. In the system 1, the smart card reader/writer 9 retrieves the playing parameter data 6 from the smart card 5 and transfers the playing parameter data 6 to the controller 8, such that the controller operates the EGM 2 in accordance with the one or more playing parameters 3.

In this embodiment, the computer 7 takes the form of a standalone computer kiosk in the gaming venue, having a device for communicating with the smart card 5 in the form of a smart card reader/writer 11, a central processing unit 12 in communication with the smart card reader/writer and a data entry assembly in the form of a virtual keyboard 13 for a user 4 to enter or update the playing parameter data 6. However, the playing parameter data 6 can also be entered using a physical keyboard. The computer kiosk 7 enables the user 4 to enter or update the player parameter data 6 using the keyboard 13 and the central processing unit 12 transfers the playing parameter data 6 to the smart card 5 using the reader/writer 11.

In the system 1, the user 4 obtains the smart card 5 from the gaming venue and inserts it into the smart card reader/writer 11 of the computer kiosk 7. The user 4 then enters the playing parameter data 6 onto the smart card 5 using the keyboard 13 of the computer kiosk 7. This playing parameter data 6 relates to the one or more playing parameters 3 to enable the user 4 desires to limit his gaming behaviour. These playing parameters comprises the maximum bet limit, banknote acceptance limit for the EGM 2, the maximum number of banknotes inserted into the EGM, the maximum monetary loss on a single machine, the maximum accumulated monetary loss, the maximum credit on the EGM, the maximum session turnover, the maximum time spent on the EGM and the maximum time spent on multiple EGMs. These parameters are further modified by introducing a predetermined time limit, based on a periodic cycle, in the form of a playing session time limit. For example, the playing session time limit for the maximum monetary loss can be set for an hourly, daily, weekly or monthly limit. Similarly, the maximum time spent on the EGM 2 can be set for an hourly, daily, weekly or monthly limit. Other periodic time limits can also be set, such as fortnightly, as desired by the user.

In addition, the computer kiosk 7 permits the user 4 to adjust the settings for the playing parameter data 6 on the smart card 5. Alternatively, the computer kiosk 7 “locks” in the initial playing parameter data 6 on the smart card 6 until expiry of the playing session time limit(s), to prevent the user from increasing his or her limits once they are reached during the playing session.

Other information can be added to the smart card 5 using the computer kiosk 7 to personalise it for the user 4. The computer kiosk 7 may also store the playing parameters 3 and, where playing parameters are adjusted, any playing history data 15 of users 4 to enable the identification of problem gambling habits or behaviours, whilst retaining the privacy and anonymity of individual problem gamblers.

The smart card 5 also stores playing history data 15 relating to the playing history of the user. The one or more playing history data comprises the number of bets made by the user, the amount of each bet made by the user, the accumulated amount of bets made by the user, the type of banknote(s) inserted into any EGM 2, the total number of banknotes inserted into EGMs, the turnover for the session on the EGM, the maximum credit on the EGM, the accumulated monetary loss of the user and the amount of time the user has been playing EGMs. The playing history data 15 can be stored for the same playing session time limits as the playing parameter data 6 (such as, an hourly, daily, weekly or monthly basis) to permit comparison with the playing parameter data 6. Again, the playing history data 15 can also be stored for other time periods, such as on a fortnightly, six monthly, yearly or permanent basis, to match the playing session time limit(s) set on the smart card 5. Thus, this enables the system 1 to regulate the gambling behaviour of the user 4 through the smart card 5.

In operation of the system 1, the user 4 first obtains a smart card 5 from a gaming venue and then sets up the initial playing parameter data 6 on the smart card 5 using the computer kiosk 7 in the gaming venue. The user 4 then inserts the card into the smart card reader/writer 9 of the EGM 2. The reader/writer 9 retrieves the playing parameter data 6 and any player history data 15 from the smart card 5, and transfers that data to the EGM controller 8, where it is stored in memory. The playing parameter data 6 and the playing history data 15 are compared by the EGM controller 8 for compliance with the one or more playing parameters 3 before the EGM controller 8 permits the user 4 to play a game on the EGM 2.

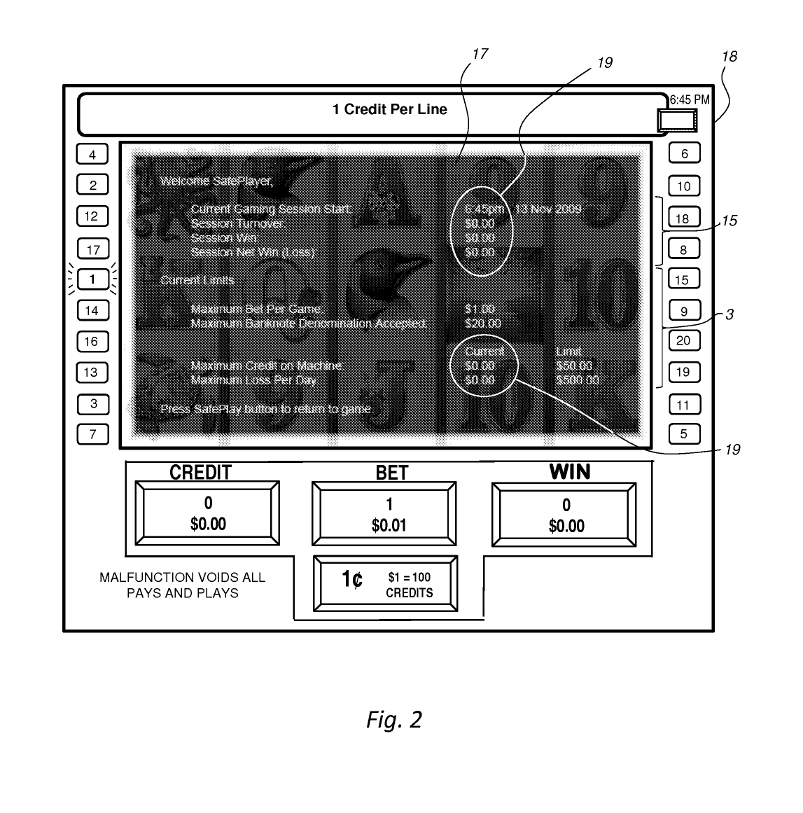

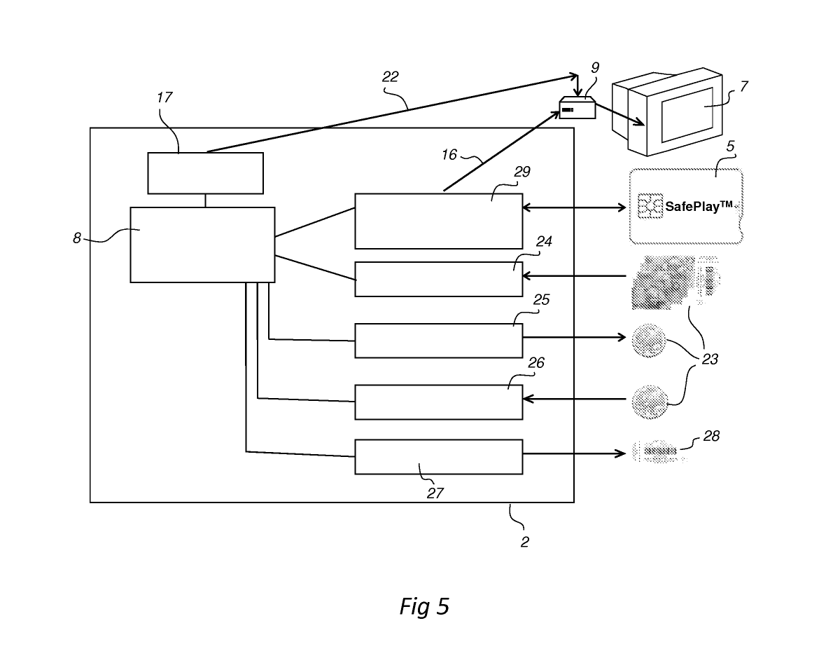

If the playing parameters 3 are complied with, then the EGM controller 8 will send a signal to the smart card 5 confirming that the verification process has been completed and playing a game on the EGM 2 is permitted. In this embodiment, the EGM controller 8 then sends a signal 16 to the reader/writer 9 (as best shown in FIG. 5), to display a status screen 17 showing the playing parameters 3 and playing history data 15 on the display screen 18 of the EGM 2, as illustrated in FIG. 2. The displayed playing parameters 3 include the maximum bet per game, the maximum banknote denomination accepted, the maximum credit on the EGM 2 and the maximum loss per day. The playing history data 15 includes the current gaming session start time and date, the monetary turnover for the session, the monetary wins for the session, the net monetary win/loss for the session, the maximum credit on the EGM 2 and the maximum loss per day. Since the user 4 has not played on any EGMs 2, the playing history data 15 shows zero values 19. While the player history data 15 is displayed, in other embodiments, the smart card 5 may choose to only display the playing parameters 3 where no player history data 15 has been recorded or has only zero values. After displaying the playing parameters 3 and the playing history data 15, the EGM controller 8 then permits the user 4 to play a game on the EGM 2.

After the game is played on the EGM 2, the EGM controller 8 updates the playing history data 15 in its memory and on the smart card 5 using the reader/writer 9. If the user 4 wishes to play another game on the same EGM 2, then the EGM controller 8 again compares the playing history data 15 (now updated) against the playing parameter data 6 in its memory to check that playing a game on the EGM 2 complies with the playing parameters 3. If so, then the EGM controller 8 permits the user to play another game on the EGM 2. This process repeats each time the user 4 plays a game on the EGM 2.

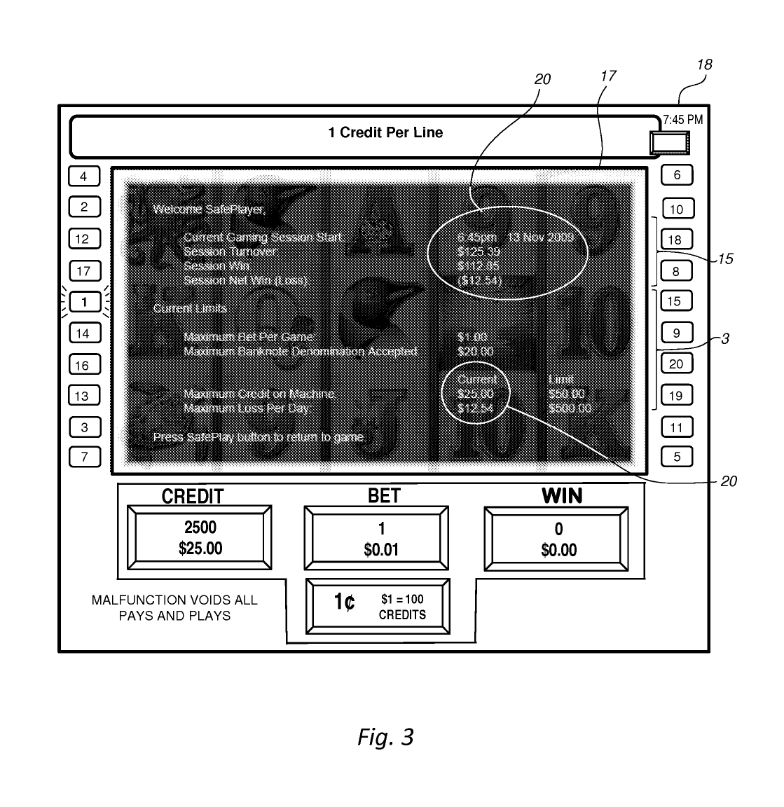

The user 4 can initiate display of the playing history data 15 and the playing parameters 3 as a status screen 17 on the display screen 18 of the EGM 2 at any time by pressing either a physical button on the EGM or touch screen button on the display screen 18, as illustrated in FIG. 3. As shown, the playing history data 15 has been updated to indicate values 20 for the monetary turnover for the session, the monetary wins for the session, the net monetary win/loss for the session, the maximum credit on the EGM and the maximum loss per day. Thus, the status screen 17 indicates to the user 4 whether he or she is approaching any of the limits set with the playing parameters 3.

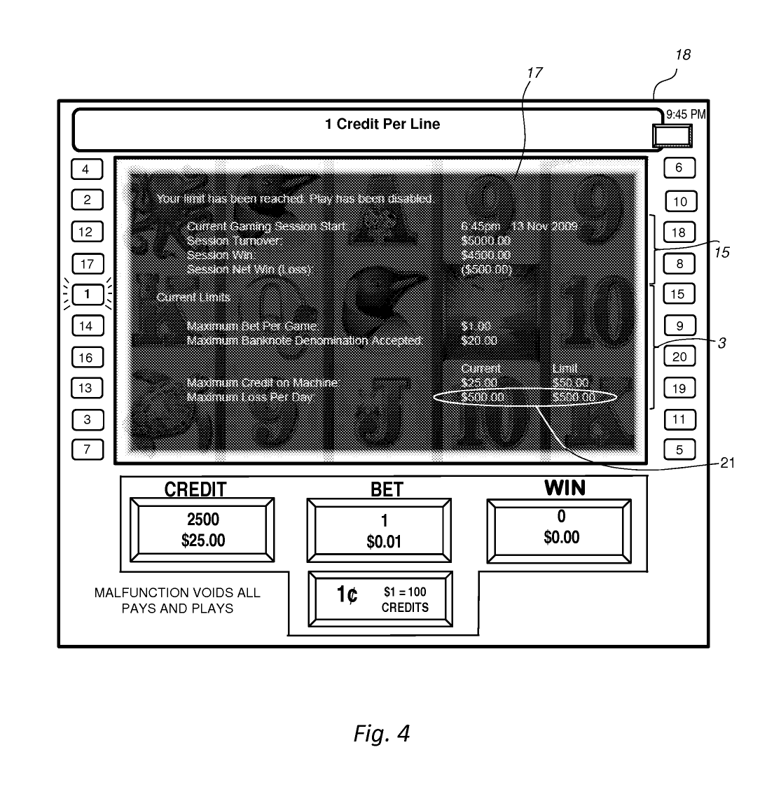

When the user 4 no longer wishes to play on the EGM 2, he or she depresses a button (either a physical button or a touch screen button) to end the game session and the smart card 5 is ejected from the reader/writer 9 with the updated playing history data 15. The user 4 may then proceed to another EGM 2 in the gaming venue and insert the smart card 5. Alternatively, the user 4 can go to a different gaming venue (in the same state or a different state) and insert the smart card 5 into another EGM 2. In either case, this restarts the process described above, where the EGM controller 8 verifies compliance with the playing parameters 3 by comparing it against the playing history data 15 and then the playing history data 15 and the playing parameters 3 are displayed before a game is played.

Where playing a game on the EGM 2 would not comply with the one or more playing parameters 3, the EGM controller 8 prevents operation of the EGM. In this case, the EGM controller 8 communicates a signal to the reader/writer 9 to display a status screen 17 on the screen 18 of the EGM 2 advising the user 4 that one or more of the playing parameters 3 have not been complied with and that the playing a game on the EGM 2 has been disabled, as illustrated in FIG. 4. As shown, the status screen 17 displays the playing parameters 3 and the playing history data 15 so that the user 4 can see which of the playing parameters would not be complied with if he or she were to play a game on the EGM 2. In this example, the maximum loss per day has reached the limit of $500 set by the playing parameters 3, as indicated by reference numeral 21.

Where the user 4 can adjust one or more of the game parameters to comply with the playing parameter 3 that is not in compliance, for example, the maximum bet limit, then the EGM controller 8 would permit the user 4 to adjust one or more parameters of the game on the EGM 2 to comply with the playing parameters. For example, if a maximum bet limit of $20 has been set on the smart card 5, but a user attempts to place a bet of $50 on the EGM, then the EGM controller 8 determines that this playing parameter has not been complied with. The EGM controller 8 instructs the reader/writer 9 to display the status screen 17 on the EGM 2 to advise the user 4 that this playing parameter is not in compliance. The EGM controller 8 then permits the user 4 to adjust the amount of the bet to enable the user 4 to comply with the player parameter 3 set by the smart card 5.

If one or more parameters of the game on the EGM 2 cannot be adjusted to comply with the playing parameters 3, then the EGM controller 8 prevents a game being played on the EGM 2. For example, where the playing parameter is the maximum monetary loss and the user 4 has reached this limit, then the EGM controller 8 would prevent the user 4 from playing a game on the EGM 2, irrespective of what game parameters are changed. The EGM 2 also ejects the smart card 5 for return to the user 4.

For the display of the status screens 17 in FIGS. 2 to 4, the reader/writer 9 retrieves the playing history data 15 and the playing parameter data 6 from the smart card 5 and generates the graphical data 16 from the playing history data 15 and/or the one or more playing parameters 3 for display on the screen 17 of the EGM 2. In the case of user activation, the EGM controller 8 communicates the user's command to display the status screen 17 to the reader/writer 9. The reader/writer 9 has an internal logic unit for generating the graphical data 16, typically as a graphical video data signal 22, independently of the EGM controller 8, as best shown in FIG. 5. The reader/writer 9 then intercepts the normal video signal generated by the EGM controller 8 (which would be displaying game information) and superimposes overlays of the graphical video data signal 22 so that it is displayed as a status screen 17 on the display screen 18 on top of any game information being displayed by the EGM controller. That is, the reader/writer 9 reprocesses the normal video signal generated by the EGM controller 8 to display the graphical video data signal 22. By using the reader/writer 11 to generate the graphical data, the system 1 can be easily retro-fitted on pre-existing EGMs 2 without the need to perform regression testing on each EGM, which would be required if the EGM controller 8 were configured to display the status screen 17.

In the system 1, the length of time that the status screens 17 in FIGS. 2 to 4 are displayed on the display screen 18 can be controlled in several ways. The system 1 may set a default display period, for example, 15 seconds, after which the display screen 18 returns to displaying game information. The display period may be set for a shorter or longer time, as required. In another option, the user 4 can trigger deactivation of any of the status screens 16 by pressing a physical button or a touch screen button. A further option is for the status screen 16 to deactivate once the user 4 presses a physical button or touch screen button to end the game session and collect his or her winnings. This also causes the smart card 5 to be ejected from the reader/writer 9 of the EGM 2. In the case of the status screen 16 of FIG. 4, the status screen 16 is deactivated before the smart card 5 is ejected from the reader/writer 9 of the EGM 2. It will be appreciated that any combination of options can be implemented in the system 1.

In the embodiment, the EGM controller 8 records session data relating to the use of the EGM 2 by the user 4. The EGM controller 8 then transfers the session data to the smart card 5 via to the reader/writer 9. This enables the smart card 5 to store and display the user's session times and betting behaviour for each EGM 2. The session data can be displayed with the playing parameters 3 and/or playing history data 15 on the EGM 2, as outlined above. That is, the session data is displayed as part of the status screen 17 on the display screen 18 of the EGM 2 upon activation by the user 4, again through a physical button or a touch screen button.

The smart card 5 is configured to reset the playing history data 15 after the playing session time limit expires, which the same as the time limits set for the user's playing parameters 3. This enables the user 4 to reuse the smart card 5 without having to obtain a new smart card 5 and repeat entering his or her individual playing parameters again. For example, a user may initially set a daily (24 hour) playing session time limit for each of his or her playing parameters 3. After 24 hours expires from when the smart card 5 was first issued or used, when the user next inserts the smart card 5 inserts into an EGM 2, the EGM controller 8 compares the playing session time recorded as part of the playing history data 15 against the playing session time limit set for the playing parameters 3, determines that the playing session time limit (for example, 24 hours) has expired and then uses the reader/writer 9 to reset the playing history data 15 on the smart card 5 to zero values. This takes place before the EGM controller 8 compares the playing history data 15 against the playing parameters 3. In addition, the EGM controller 8 restarts the playing session time, which is also written back onto the smart card 5. This effectively restarts the playing session time limit (for example, 24 hours) for the user to play games on the EGM 2 up to the limits set by the playing parameters 3.

Referring to FIG. 5, retrofitting the system 1 to a pre-existing EGM is illustrated, where corresponding features have been given the same reference numerals. The EGM 2 has standard devices for receiving money from and giving money 23 to the user 4, which include a banknote acceptor slot 24, a coin acceptor 25, a hopper 26 and a ticket printer 27 for issuing receipts 28 for a user to take to a counter in return for money 23. Each of these devices is in electronic communication with the EGM controller 8 in the form a main board of the EGM 2. The EGM controller 8 is in electronic communication with the display screen 18 for displaying game and other information, including the graphical data 16 to display the playing parameters 3 and the playing history data 15. All that is required to implement the system 1 is the installation of the smart card and video interface 29, together with the reader/writer 9 alongside the monetary devices 24, 25, 26 and 27 on the EGM 2 and providing the computer kiosk 7 for initialising the playing parameter data 6 on the smart card 5. In addition, the EGM controller 8 will require additional software protocols for communicating with the smart card 5 for managing and handling the playing parameter data 6, the playing history data 15 and session data. Similarly, the reader/writer 9 has software protocols for communicating with the smart card 5 for transferring, managing and handling the playing parameter data 6, the playing history data 15 and session data, as well as the logic unit for generating the graphical data 16 for the status screen 17. Thus, there is a minimal cost and inconvenience in the installation of the system 1.

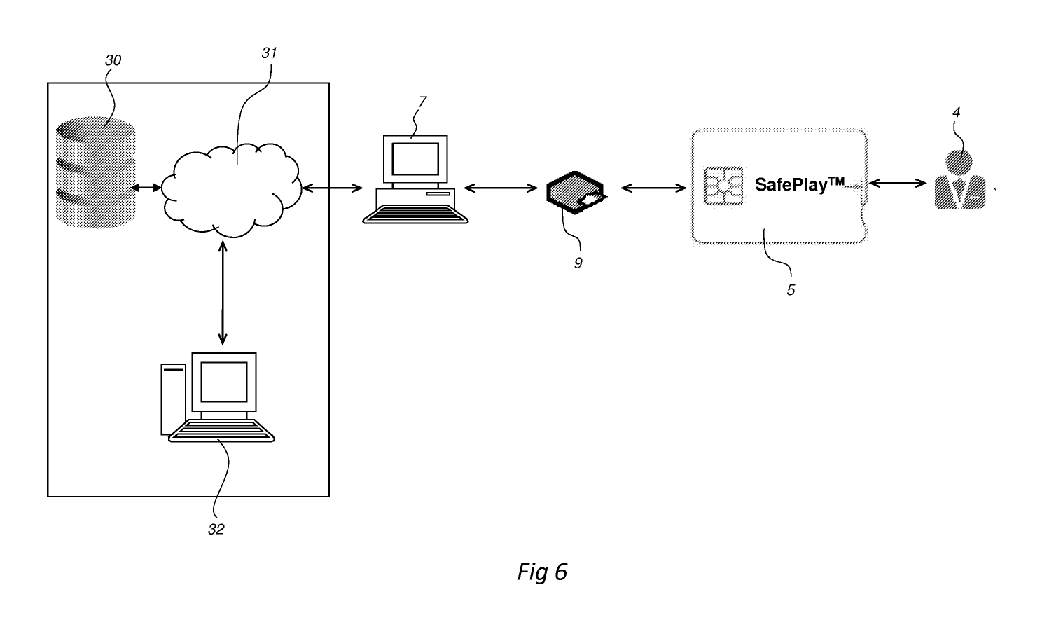

Referring to FIG. 6, a further embodiment of the invention is illustrated, where corresponding features have been given the same reference numerals. In this embodiment, the computer kiosk 7 is in electronic communication with a central database 30 (via the internet 31) for verifying the playing parameter data 6 on the smart card 5. Alternatively or additionally, the computer kiosk 7 is in communication with a separate validation computer 32 for verifying the playing parameter data 6 on the smart card 5. Furthermore, the validation computer 32 may be used to activate the smart card 5 for use with the EGM 2 as a separate and additional step to the user 4 entering or updating the playing parameter data 6 on the smart card 5 using the computer kiosk 7.

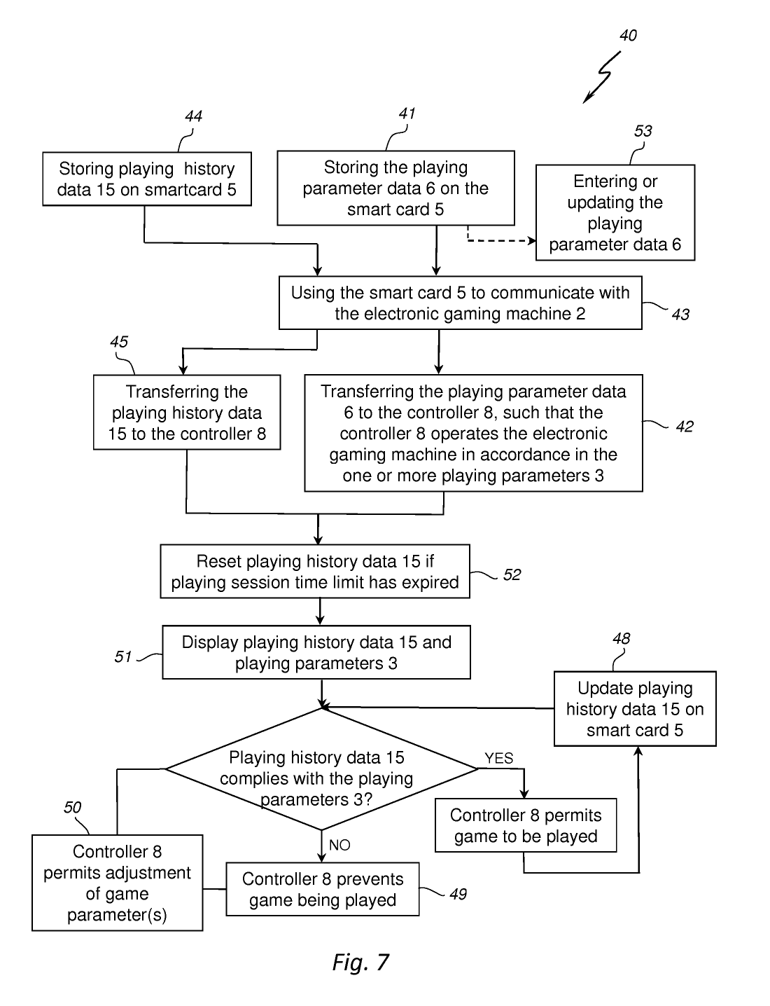

Referring to FIG. 7, another aspect of the invention in one embodiment is illustrated, where corresponding features have been given the same reference numerals. In this embodiment, a method 40 of controlling an EGM 2 in accordance with one or more playing parameters 3 comprises the step 41 of storing playing parameter data 6 relating to the one or more playing parameters 3 on a computer programmable medium in the form of a smart card 5 and the step 42 of transferring the playing parameter data 6 from the smart card 5 to a controller 8 of the EGM 2, such that the controller operates the EGM in accordance with the one or more playing parameters 3.

The method 40 further comprises the step 43 of using the smart card 5 to communicate with the EGM controller 8 of the EGM 2 between the storing step 41 and the data transfer step 42.

The method 40 works in a similar fashion to the system 1. That is, the user stores playing parameter data 6 on the smart card as per the storing step 41. Then the smart card 5 is used to communicate with the EGM 2, preferably via a smart card reader/writer 9, at step 43. The playing parameter data 6 is then transferred from the smart card 5 to the EGM controller 8 so that the EGM controller 8 operates the EGM 2 in accordance with the playing parameters 3 on the smart card 5, at the data transfer step 42.

The method 40 also stores the playing history data 15 relating to the user on the smart card 5 at step 44 and transfers it from the smart card 5 to the EGM controller 8 for storage in memory at step 45. Furthermore, the method 40 comprises the step 46 of comparing the playing history data 15 with the playing parameter data 6 for compliance with the playing parameters 3, before permitting the user to play a game on the EGM 2. The data comparing step 46 is performed before each game that is played on the EGM 2. In another embodiment, the data comparing step is performed after each game is played. If playing a game on the EGM 2 would comply with the playing parameters 3, then the EGM controller 8 permits the user to play a game on the EGM at step 47.

After the game is played, the method 40 comprises the step 48 of updating the playing history data on the smart card 5. The method then repeats the data comparing step 46, the game permission step 47 and the data updating step 48.

If playing a game on the EGM 2 would not comply with the one or more playing parameters 3, then the EGM controller 8 prevents the game being played on the EGM at step 49. The EGM controller 8 also instructs the reader/writer 9 to display a status screen 17 on the EGM 2 advising the user that one or more of the playing parameters would not be complied with.

The EGM controller 8 then permits the user to adjust one or more parameters of the game on the EGM to comply with the one or more playing parameters at step 50, after which the process returns to the data comparing step 46 to determine compliance with the playing parameters 3.

The method 40 also comprises the step 51 of displaying the playing history data 15 and/or the one or more playing parameters 3 on the EGM 2 at the start of play. This involves retrieving the playing history data 15 and the playing parameter data 6 from the smart card 5 and generating graphical data 16 from the playing history data 15 and/or the one or more playing parameters 3 for display as a status screen 17 on the display screen 18 of the EGM 2. As described in relation to the system 1, the displaying step 51 is performed when the user 4 first inserts the smart card 5 and upon activation by the user 4 pressing a physical button or a touch screen button. In this latter case, the EGM controller 8 communicates with the reader/writer 9 to activate display of the playing history data 15 and playing parameters 3.

In addition to the data updating step 48, the method 40 may also record session data relating to the use of the EGM 2 by the user 4. This session data can be displayed with the playing parameters 3 and playing history data 15 on the status screen 17 using the display screen 18 of the EGM 2. Again, the session data may be displayed on the EGM 2 upon activation by the user 4.

The method 40 also comprises the step 52 of resetting the playing history data 15 after expiry of a predetermined time limit in the form a playing session time limit. In this embodiment, the playing session time limit corresponds to the time limits for the playing parameters 3 to enable multiple use of the smart card 5 without having obtained a new smart card and repeating the storing step 41.

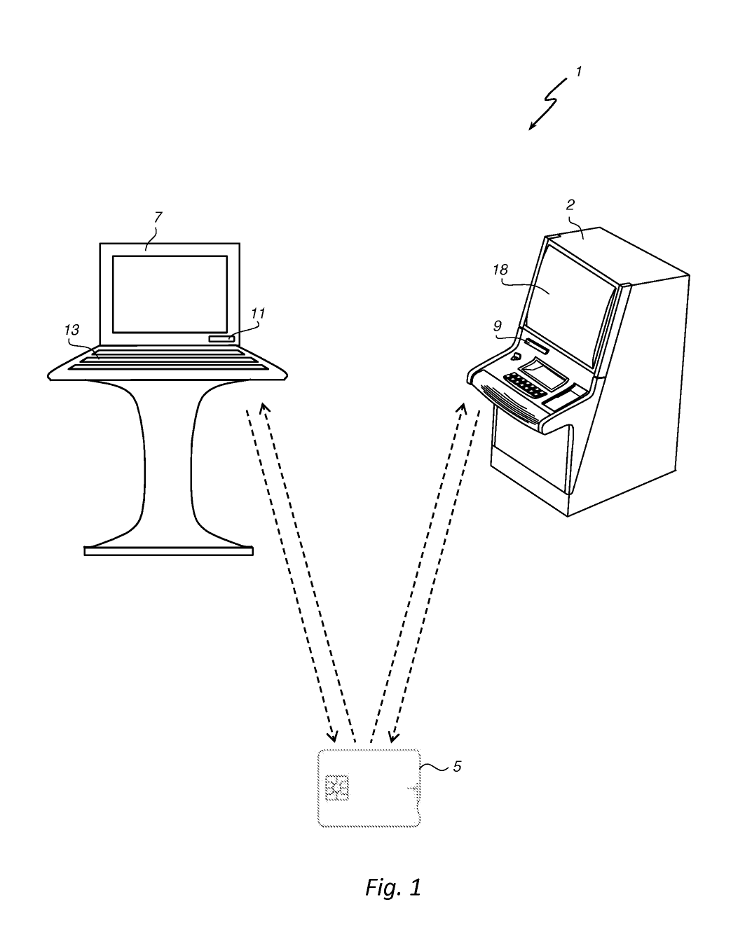

The storing step 41 may also include the step 53 of entering or updating the playing parameter data 6 on the smart card 5 using a computer in the form of a standalone computer kiosk 7 for receiving the smart card 5. The addition of step 53 essentially emulates the full system 1 of FIG. 1.

While the preferred embodiments have been described using a contact smart card 5 as the computer programmable medium and a smart card reader/writer 9 as the communicating device, it will be appreciated that the system 1 and method 40 of the invention can be implemented using other specific forms of data transfer. For example, in other embodiments, the computer programmable medium is a radio frequency identification (RFID) device and the communicating device is a RFID communication device. Another embodiment employs a “contactless” smart card that the user may simply swipe over a card reader/writer to permit data transfer between the smart card and the controller of the EGM 2. Other suitable forms for the computer programmable medium and the communicating device include, but are not limited to, a USB key, magnetic card and other equivalent portable electronic storage devices, and their corresponding reader/writer devices.

In the embodiments of the system 1 and method 40, the smart cards 5, reader/writer 9 and computer kiosk 9 are configured to securely store the playing parameters 3, playing parameter data 6 and the playing history data 15, in order to protect the information and the anonymity/privacy of the user 4.

The system 1 and method 40 can be easily implemented across all state jurisdictions to comply with any specific requirements in each state. Moreover, there is no need to provide a central control system for a group of EGMs 2 in a gaming venue, since the smart card 5 in the system 1 and the method 40 communicates directly with the EGM 2 that is being played by the user 4.

Thus, the preferred forms of the invention provide a system and method where a problem gambler is able to set individual playing parameters for playing an EGM that will ensure that he or she does not exceed self-imposed betting or spending limits. Consequently, a problem gambler may safely play EGMs without worrying about whether he or she will lose control and spend too much money or time gambling. The system and method of the invention also provides some measure of privacy and anonymity for the user, and thus removes the privacy concerns involved with existing enforcement measures and encourages cooperation of the problem gambler. Therefore, the invention reduces the adverse personal, social, economic and health effects upon the problem gambler and his or her family.

In addition, the system and method enables gaming venues and operators, such as casinos, clubs and pubs, to comply with their legal and regulatory requirements. It also avoids misidentification of people as problem gamblers, as it allows problem gamblers to discretely obtain smart cards for controlling the EGM without affecting other recreational gamblers. As the system and method only requires minor modifications to the EGM, the invention can be implemented on existing gaming machines with ease and convenience while incurring relatively little cost. In particular, the invention enables the comparison of the playing history data against the playing parameter data to be performed locally by the EGM controller without requiring a separate, dedicated computer or database that needs to be linked to each EGM. In all these respects, the invention represents a practical and commercially significant improvement over the prior art.

Although the invention has been described with reference to specific examples, it will be appreciated by those skilled in the art that the invention may be embodied in many other forms.

1. A system for controlling an electronic gaming machine in accordance with one or more playing parameters of a user, the system comprising:
a computer programmable medium for storing playing parameter data relating to the one or more playing parameters;
a computer for receiving the computer programmable medium, wherein the user enters or updates the playing parameter data on the computer programmable medium; and
an electronic gaming machine comprising:
a controller for controlling operation of the electronic gaming machine; and
a device for communicating with the computer programmable medium,
wherein the communicating device retrieves the playing parameter data from the computer programmable medium and transfers the playing parameter data to the controller, such that the controller uses the playing parameter data to operate the electronic gaming machine in accordance with the one or more playing parameters.

2. The system of claim 1, wherein the computer programmable medium stores playing history data relating to the playing history of the user, and the communicating device retrieves the playing history data from the computer programmable medium and transfers the playing history data to the controller, wherein the controller compares the playing history data with the playing parameter data for compliance with the one or more playing parameters before permitting the user to play a game on the electronic gaming machine.

3. The system of claim 2, wherein after each game that is played on the electronic gaming machine, the controller updates the playing history data on the computer programmable medium.

4. The system of claim 2 or 3, wherein before each game that is played on the electronic gaming machine, the controller compares the playing history data against the playing parameter data to check that playing a game on the electronic gaming machine complies with the one or more playing parameters.

5. The system of claim 2 or 3, wherein after each game that is played on the electronic gaming machine, the controller compares the playing history data against the playing parameter data to check that playing another game on the electronic gaming machine complies with the one or more playing parameters.

6. The system of any one of claims 1 to 5, wherein the controller permits the user to play a game on the electronic gaming machine where playing a game on the electronic gaming machine would comply with the one or more playing parameters, and the controller prevents operation of the electronic gaming machine where playing a game on the electronic gaming machine would not comply with the one or more playing parameters.

7. The system of any one of claims 1 to 6, wherein the electronic gaming machine permits the user to adjust one or more predetermined parameters of the game on the electronic gaming machine to comply with the one or more playing parameters.

8. The system of any one of claims 1 to 7, wherein the one or more playing parameters comprises the maximum bet limit, banknote acceptance limit for the electronic gaming machine, the maximum number of banknotes inserted into the electronic gaming machine, the maximum monetary loss on a single machine, the maximum credit on the electronic gaming machine, the maximum accumulated monetary loss, the maximum session turnover, the maximum time spent on the electronic gaming machine and the maximum time spent on multiple electronic gaming machines.

9. The system of any one of claims 1 to 8, wherein the one or more playing parameters have one of more predetermined time limits.

10. The system of claim 9, wherein at least one of the predetermined time limits is a playing session time limit.

11. The system of any one of claims 2 to 10, wherein the playing history data comprises one or more of the number of bets made by the user, the amount of each bet made by the user, the accumulated amount of bets made by the user, the denomination of banknote(s) inserted into any electronic gaming machine, the total number of banknotes inserted into electronic gaming machines, the turnover for the session on the electronic gaming machine, the maximum credit on the electronic gaming machine, the accumulated monetary loss of the user and the amount of time the user has been playing electronic gaming machines.

12. The system of any one of claims 2 to 11, wherein the playing history data and/or the one or more playing parameters are visually displayed on the electronic gaming machine to the user before a game is played on the electronic gaming machine.

13. The system of any one of claims 2 to 11, wherein the playing history data and/or the one or more playing parameters are visually displayed on the electronic gaming machine in response to a command from the user.

14. The system of claim 12 or 13, wherein the communicating device retrieves the playing history data and the playing parameter data from the computer programmable medium and generates graphical data of the playing history data and/or the one or more playing parameters for display on the electronic gaming machine.

15. The system of any one of claims 2 to 14, wherein the controller records session data relating to the use of the electronic gaming machine by the user, the communicating device transfers the session data from the controller to the computer programmable medium and the session data is displayed with the playing parameters and/or playing history data on the electronic gaming machine.

16. The system of any one of claims 2 to 15, wherein the playing history data is reset after expiry of the one or more predetermined time limits.

17. The system of claim 16, wherein the one or more predetermined time limits correspond to the time limits for the playing parameters.

18. The system of any one of claims 1 to 17, wherein the computer programmable medium comprises a memory card, smart card, a radio frequency identification (RFID) device, USB key, magnetic card or other equivalent portable electronic storage device.

19. The system of any one of claims 1 to 18, wherein the communicating device comprises a memory card reader/writer, a smart card reader/writer, a RFID communication device, USB key reader/writer, magnetic card reader/writer or other equivalent portable electronic storage device reader/writer.

20. A method of controlling an electronic gaming machine in accordance with one or more playing parameters of a user, the method comprising the steps of:
storing playing parameter data relating to the one or more playing parameters on a computer programmable medium; and
transferring the playing parameter data from the computer programmable medium to a controller of the electronic gaming machine, such that the controller uses the playing parameter data to operate the electronic gaming machine in accordance with the one or more playing parameters.

21. The method of claim 20, further comprising the steps of storing playing history data relating to the playing history of the user, transferring the playing history data from the computer programmable medium to the controller and comparing the playing history data with the playing parameter data for compliance with the one or more playing parameters, before permitting the user to play a game on the electronic gaming machine.

22. The method of claim 21, further comprising the step of performing the data comparing step before each game that is played on the electronic gaming machine.

23. The method of claim 21, further comprising the step of updating the playing history data on the computer programmable medium after each game that is played on the electronic gaming machine.

24. The method of claim 23, wherein the data comparing step is performed after the playing history data updating step.

25. The method of any one of claims 20 to 24, further comprising the steps of permitting the user to play a game on the electronic gaming machine if playing a game on the electronic gaming machine would comply with the one or more playing parameters and preventing operation of the electronic gaming machine if playing a game on the electronic gaming machine would not comply with the one or more playing parameters.

26. The method of any one of claims 20 to 25, further comprising the step of permitting the user to adjust one or more parameters of the game on the electronic gaming machine to comply with the one or more playing parameters.

27. The method of any one of claims 21 to 26, further comprising the steps of retrieving the playing history data and the playing parameter data from the computer programmable medium and generating graphical data from the playing history data and/or the one or more playing parameters for display on the electronic gaming machine.

28. The method of claim 27, wherein the displaying step is performed before a game is played on the electronic gaming machine.

29. The method of claim 27, wherein the user activates the displaying step.

30. The method of any one of claims 20 to 29, further comprising the steps of recording session data relating to the use of the electronic gaming machine by the user and displaying the session data with the playing parameters and/or playing history data on the electronic gaming machine.

31. The method of claims 30, wherein the session data displaying step is performed upon activation by the user.

32. The method of any one of claims 21 to 31, wherein the method comprises the step of resetting the playing history data after expiry of the one or more predetermined time limits.

33. The method of claim 32, wherein the one or more predetermined time limits correspond to the time limits for the playing parameters.
